(19) United States
(12) Patent Application Publication
(10) Pub. No.: US 2025/0326199 A1
(43) Pub. Date: Oct. 23, 2025

(54) CASING PLATE

(71) Applicants: Micro-Star Int’l Co., Limited., New Taipei City (TW); MSI Electronic (Kun Shan) Co.,Ltd., Kunshan (CN)

(72) Inventor: Po-Chih Huang, New Taipei City (TW)

(21) Appl. No.: 18/738,301

(22) Filed: Jun. 10, 2024

(30) Foreign Application Priority Data
Apr. 23, 2024 (TW) 113204070

(51) Int. Cl. B32B 3/06; B32B 15/04

(52) U.S. Cl. CPC B32B 3/06; B32B 15/04; B32B 2307/7376; B32B 2457/00

(57) ABSTRACT

A casing plate includes a rigid board and an inorganic protective layer. The rigid board includes a first surface, a second surface, and a circumferential wall. A distance between the first surface and the second surface ranges from 0.6 mm to 1.8 mm. At least two dovetail grooves are formed on the second surface, and a depth of each dovetail groove ranges from 0.3 mm to 1.2 mm. The inorganic protective layer covers the first surface, the second surface, the circumferential wall, and a bottom surface and wall surfaces of each dovetail groove. Through the design of the dovetail grooves, the dovetail grooves may be used as hooking points when the inorganic protective layer is manufactured on the surface of the rigid board, so that the inorganic protective layer can completely cover the rigid board without subsequent cutting, thereby improving aesthetics and avoiding rust.

### CROSS-REFERENCE TO RELATED APPLICATION

This non-provisional application claims priority under 35 U.S.C. § 119(a) to patent application Ser. No. 11/320,4070 filed in Taiwan, R.O.C. on Apr. 23, 2024, the entire contents of which are hereby incorporated by reference.

### BACKGROUND

### Technical Field

The present invention relates to the field of electronics, and in particular, to a casing plate.

### Related Art

In a conventional casing, a protective film layer is generally formed on a surface of the casing in a manner of electroplating, anodizing, chemical formation, or the like, to provide an appearance color design in addition to corrosion protection.

Conventionally, the electroplating, anodizing, or chemical formation is performed through wet process treatment in batches. In a common manner, a side of a casing is clamped by a jig, and the casing is suspended on a hanging holder. Casings are then immersed in a chemical tank in batches to grow a protective film layer.

However, because the part clamped by the jig tends to cause uneven growth of the protective film layer, which may cause uneven appearance, edges are generally cut, and the remaining area with film formation completed is kept. However, these cut areas may become areas with rust and stress concentration. For corrosion protection and aesthetics, it is currently common to add a plastic or rubber protection block for protection. However, restrictions for a light weight and a small thickness are also directly affected.

### SUMMARY

To solve the problems faced in the prior art, a casing plate is provided. In some embodiments, a casing plate includes a rigid board and an inorganic protective layer. The rigid board includes a first surface, a second surface, and a circumferential wall. The first surface is opposite to the second surface, a distance between the first surface and the second surface ranges from 0.6 mm to 1.8 mm, the circumferential wall connects the first surface and the second surface, at least two dovetail grooves are formed on the second surface, and a depth of each dovetail groove ranges from 0.3 mm to 1.2 mm. The inorganic protective layer covers the first surface, the second surface, the circumferential wall, and a bottom surface and wall surfaces of each dovetail groove.

In some embodiments, the inorganic protective layer is a metal layer or a metal compound layer. More specifically, in some embodiments, the metal compound layer is a metal oxide layer.

In some embodiments, the rigid board is selected from the group consisting of a metal board, a fiber-reinforced plastic board, a glass board, and a ceramic board.

In some embodiments, an acute angle is formed between the bottom surface and at least one of the wall surfaces of the dovetail groove. More specifically, in some embodiments, the acute angle ranges from 20 degrees to 80 degrees.

In some embodiments, the depth of the dovetail groove ranges from 0.4 mm to 0.6 mm.

In some embodiments, four dovetail grooves are provided on the rigid board, and the four dovetail grooves are symmetrically arranged on the second surface.

In some embodiments, the bottom surface of the dovetail groove has a circular shape, a round rectangle shape, a semicircular shape, or a semi-round rectangle shape.

In some embodiments, the distance between the first surface and the second surface ranges from 0.8 mm to 1.5 mm.

It may be understood through the foregoing embodiments that through the design of the dovetail grooves on the rigid board, the dovetail grooves may be used as hooking points for suspending the rigid board when the inorganic protective layer is manufactured, so that the inorganic protective layer can completely cover the rigid board without subsequent cutting and processing, thereby improving aesthetics and avoiding rust, and a lighter and thinner design can be further implemented.

### BRIEF DESCRIPTION OF THE DRAWINGS

FIG. 1 is a top view of a first embodiment of a casing plate.

FIG. 2 is a cross-sectional view of an embodiment of a cross-section A-A in FIG. 1.

FIG. 3 is a partial enlarged schematic diagram of suspending a rigid board for a process.

FIG. 4 is a cross-sectional view of an embodiment of a cross-section B-B in FIG. 1.

FIG. 5 is a cross-sectional view of another embodiment of a cross-section B-B in FIG. 1.

FIG. 6 is a top view of a second embodiment of a casing plate.

FIG. 7 to FIG. 9 are top views of a third embodiment to a fifth embodiment of a casing plate.

### DETAILED DESCRIPTION

In the following description, terms “first”, “second”, and “third” are only used to distinguish one component, member, area, layer or section from another component, member, area, layer, or section, rather than indicating an inevitable sequence therebetween. In addition, relative terms such as “under”, “on”, “inside”, and “outside” may be used herein to describe a relationship between one component and another component. It should be understood that relative terms are intended to include differences in devices other than the devices at the orientation shown in the drawing. For example, if the device in one accompanying drawing is flipped, components described as being on “lower” sides of other components are to be oriented on “upper” sides of the other components. This only represents a relative position relationship, not an absolute position relationship.

In the accompanying drawings, the widths of some components, areas, and the like are enlarged for clarity. Throughout the specification, same reference numerals indicate same components. It should be understood that when a component or the like is referred to as being “on” or “connected” to another component, it may be directly on or connected to the another component, or an intervening component may be present. In contrast, when a component is referred to as being “directly on” or “directly connected to” another component, no intervening component is present.

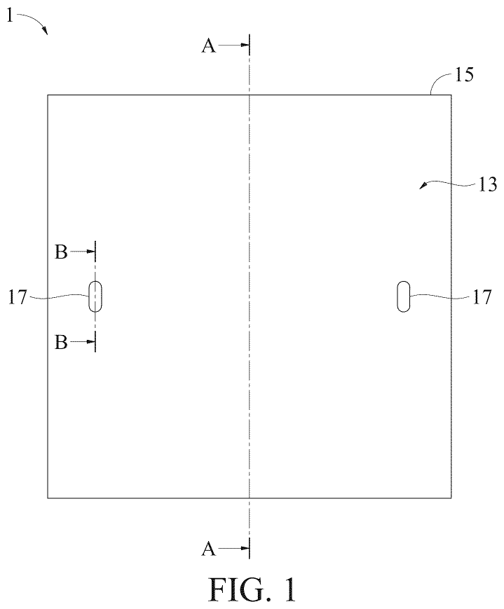

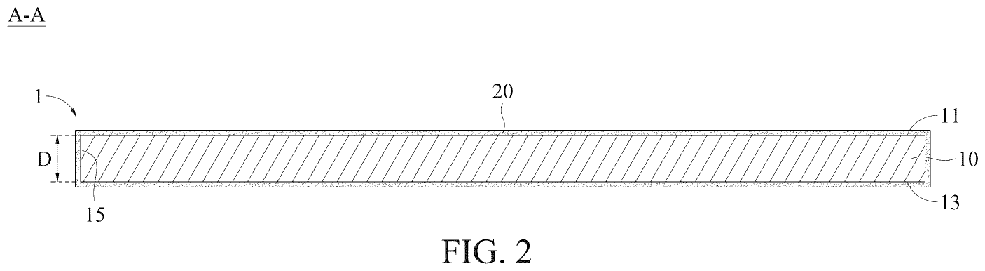

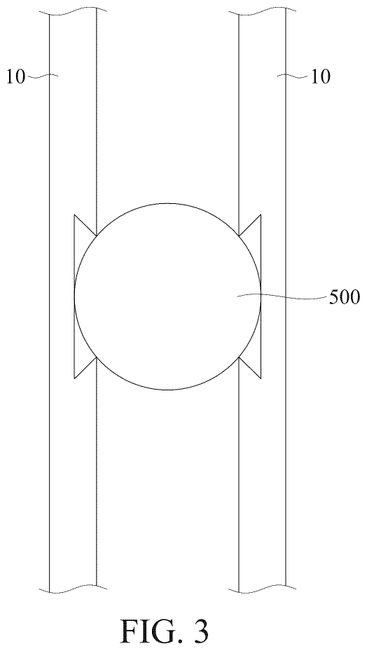

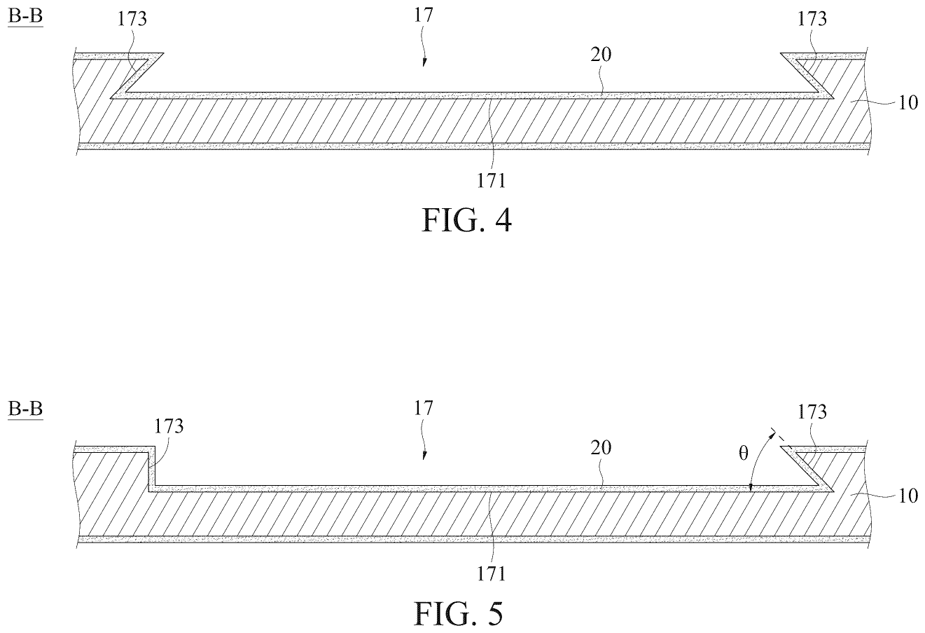

FIG. 1 is a top view of a first embodiment of a casing plate. FIG. 2 is a cross-sectional view of an embodiment of a cross-section A-A in FIG. 1. FIG. 3 is a partial enlarged schematic diagram of suspending a rigid board for a process. FIG. 4 is a cross-sectional view of an embodiment of a cross-section B-B in FIG. 1. As shown in FIG. 1 to FIG. 4, in a first embodiment, a casing plate 1 includes a rigid board 10 and an inorganic protective layer 20. The rigid board 10 includes a first surface 11, a second surface 13, and a circumferential wall 15. The first surface 11 is opposite to the second surface 13, and the circumferential wall 15 connects the first surface 11 and the second surface 13. A distance D between the first surface 11 and the second surface 13, that is, a thickness of the rigid board 10 ranges from 0.6 mm to 1.8 mm. Preferably, in some embodiments, the distance D between the first surface 11 and the second surface 13 ranges from 0.8 mm to 1.5 mm. The casing plate 1 may be mainly used in a casing of a notebook computer or a tablet computer.

The first surface 11 is generally a surface facing the outside of the casing plate 1. At least two dovetail grooves 17 are formed on the second surface 13. A depth of each dovetail groove 17 ranges from 0.3 mm to 1.2 mm. Preferably, in some embodiments, the depth of the dovetail groove 17 ranges from 0.4 mm to 0.6 mm, that is, a thickness of the dovetail groove 17 is approximately half of that of the rigid board 10. The inorganic protective layer 20 completely covers the first surface 11, the second surface 13, the circumferential wall 15, and a bottom surface 171 and wall surfaces 173 of each dovetail groove 17.

The rigid board 10 is selected from the group consisting of a metal board, a fiber-reinforced plastic board, a glass board, and a ceramic board, or may be a composite board of the foregoing materials. An appropriate material may be selected in practice according to required appearance, strength, and toughness for use. However, the foregoing is only an example, and the material is not limited thereto in practice. The inorganic protective layer 20 may be a metal layer or a metal compound layer, for example, a metal oxide layer, or the like, formed by a material fitting the rigid board 10 through electroplating, anodizing, and chemical formation, to provide an appearance color and corrosion protection.

FIG. 3 is a partial enlarged schematic diagram of suspending a rigid board for a process. As shown in FIG. 3, the dovetail grooves 17 are used as hanging points for suspending the rigid board 10 to perform electroplating, anodizing, and chemical formation. Generally, a spherical hanger 500 is held against the dovetail grooves 17 of two rigid boards 10. Because a chemical solution in a chemical solution tank provides buoyancy, at least two dovetail grooves 17 are generally provided on the rigid board 10 to ensure a position of the rigid board 10 when the inorganic protective layer 20 is manufactured. Because a clamping manner of clamping on a side of the rigid board 10 is not used, the inorganic protective layer 20 may completely cover an outer surface of the rigid board 10. In addition, because gaps exist between the hanger 500 and the dovetail grooves 17, the chemical solution may still enter, and the inorganic protective layer 20 is also generated on the bottom surface 171 and the wall surfaces 173 of the dovetail grooves 17.

In addition, the inorganic protective layer 20 from the first surface 11 to the circumferential wall 15 is continuous, smooth, and complete, and meets a demand of required appearance of the casing plate 1.

FIG. 5 is a cross-sectional view of another embodiment of a cross-section B-B in FIG. 1. As shown in FIG. 5, and referring to FIG. 4 simultaneously, as shown in FIG. 4, in some embodiments, the dovetail groove 17 has an oblique angle Θ on each of two sides. As shown in FIG. 5, in some embodiments, the dovetail groove 17 may have an oblique angle Θ on only a single side. The oblique angle Θ is an angle between the bottom surface 171 and the wall surface 173 of the dovetail groove 17, and is an acute angle. Preferably, in some embodiments, the oblique angle Θ ranges from 20 degrees to 80 degrees. More preferably, in some embodiments, the oblique angle Θ ranges from 45 degrees to 60 degrees.

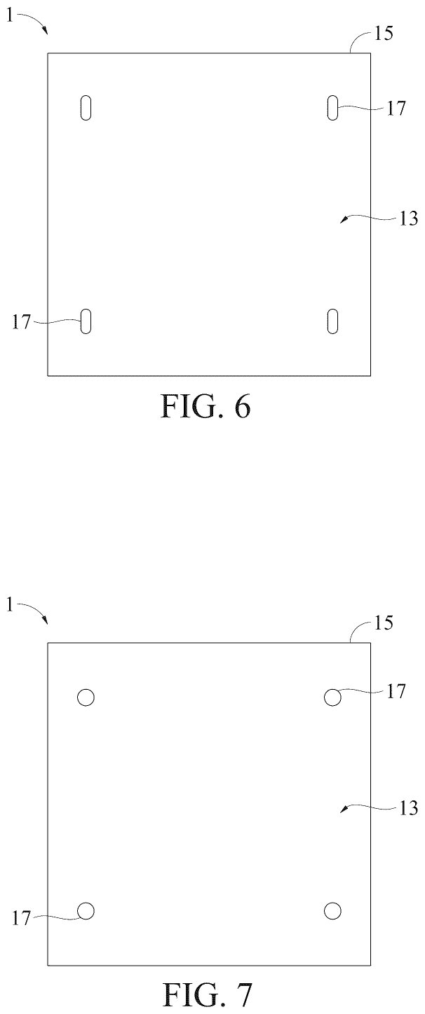

FIG. 6 is a top view of a second embodiment of a casing plate. In some embodiments, for higher process stability, four dovetail grooves 17 are provided on the rigid board 10, and the four dovetail grooves are symmetrically arranged on the second surface 13. However, a quantity of the dovetail grooves 17 is only an example, but does not constitute a limitation.

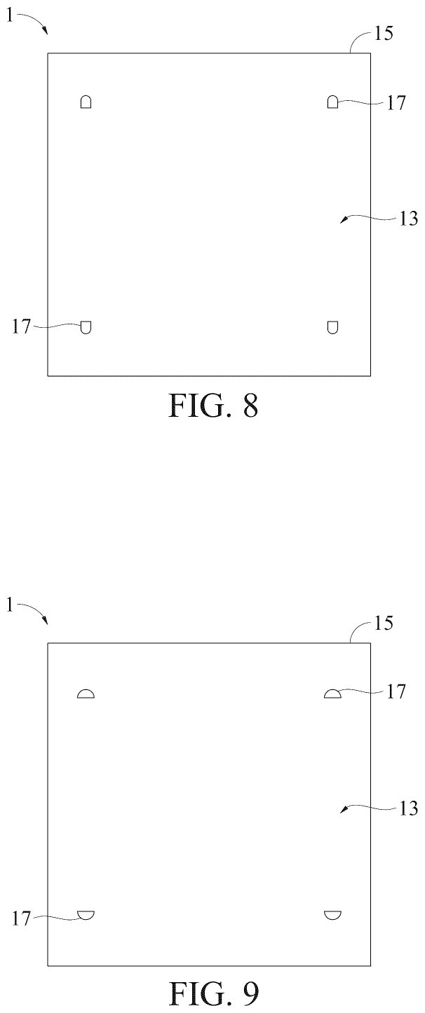

FIG. 7 to FIG. 9 are top views of a third embodiment to a fifth embodiment of a casing plate. As shown in FIG. 7 to FIG. 9, and referring to FIG. 1 and FIG. 5 and FIG. 6 simultaneously, further, the dovetail grooves 17 may be designed into different shapes in different embodiments, provided that the dovetail grooves can fit the hanger 500. For example, as shown in FIG. 6 to FIG. 9, the bottom surface 171 of the dovetail groove 17 may respectively have a round rectangle shape, a circular shape, a semi-round rectangle shape, and a semicircular shape. However, the foregoing is only an example, but does not constitute a limitation.

Through the foregoing detailed description, through the design of the dovetail grooves 17 on the rigid board 10, the dovetail grooves may be used as hooking points for suspending the rigid board 10 when the inorganic protective layer 20 is manufactured, so that the inorganic protective layer 20 can completely cover the rigid board 10 without subsequent cutting and processing, thereby improving aesthetics and avoiding rust, and a lighter and thinner design can be further implemented.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A casing plate, comprising:
a rigid board, comprising a first surface, a second surface, and a circumferential wall, wherein the first surface is opposite to the second surface, a distance between the first surface and the second surface ranges from 0.6 mm to 1.8 mm, the circumferential wall connects the first surface and the second surface, at least two dovetail grooves are formed on the second surface, and a depth of each dovetail groove ranges from 0.3 mm to 1.2 mm; and
an inorganic protective layer, covering the first surface, the second surface, the circumferential wall, and a bottom surface and a plurality of wall surfaces of each dovetail groove.

2. The casing plate according to claim 1, wherein the inorganic protective layer is a metal layer or a metal compound layer.

3. The casing plate according to claim 2, wherein the metal compound layer is a metal oxide layer.

4. The casing plate according to claim 1, wherein the rigid board is selected from the group consisting of a metal board, a fiber-reinforced plastic board, a glass board, and a ceramic board.

5. The casing plate according to claim 1, wherein an acute angle is formed between the bottom surface and at least one of the wall surfaces of the dovetail groove.

6. The casing plate according to claim 5, wherein the acute angle ranges from 20 degrees to 80 degrees.

7. The casing plate according to claim 1, wherein the depth of the dovetail groove ranges from 0.4 mm to 0.6 mm.

8. The casing plate according to claim 1, wherein four dovetail grooves are provided on the rigid board, and the four dovetail grooves are symmetrically arranged on the second surface.

9. The casing plate according to claim 1, wherein the bottom surface of the dovetail groove has a circular shape, a round rectangle shape, a semicircular shape, or a semi-round rectangle shape.

10. The casing plate according to claim 1, wherein the distance between the first surface and the second surface ranges from 0.8 mm to 1.5 mm.
